(19) United States
(12) Patent Application Publication
(10) Pub. No.: US 2026/0302961 A1
(43) Pub. Date: Oct. 1, 2026

(54) CHIP ARCHITECTURE OF ISOLATED CONVERTER AND ISOLATED CONVERTER

(71) Applicant: Joulwatt Technology Co., Ltd., Hangzhou City (CN)

(72) Inventors: Yang YANG, Hangzhou (CN); Changwei GONG, Hangzhou (CN); Yingyan HE, Hangzhou (CN)

(21) Appl. No.: 19/573,338

(22) Filed: Mar. 20, 2026

(30) Foreign Application Priority Data
Mar. 26, 2025 (CN) 202510366236.5

(51) Int. Cl. H02M 3/335

(52) U.S. Cl. CPC H02M 3/33592

(57) ABSTRACT

A chip architecture of an isolated converter and an isolated converter are disclosed. The chip architecture comprises a primary side control unit, an isolated communication unit, and a secondary side control unit. The primary side control unit comprises a primary side control chip, a primary side drive chip, and a primary side transistor, at least some of which can be designed independently. The isolated communication unit comprises a primary demodulation chip and a secondary modulation chip in co-packaged. The secondary side control unit comprises a secondary side main control chip and a secondary side rectification transistor. The secondary side main control chip controls the secondary side rectification transistor and communicates with the primary side control chip through the secondary side modulation chip and primary side demodulation chip. This chip architecture can form multiple co-package combinations, reduce chip development costs, enhance co-package flexibility, and greatly improves applicability to different application scenarios.

### CROSS-REFERENCE TO RELATED APPLICATIONS

This present disclosure claims priority to a Chinese patent application No. 202510366236.5, filed on March 26, 2025, and entitled "Chip Architecture of Isolated Converter and Isolated Converter", the entire contents of which are incorporated herein by reference, including the specification, claims, drawings and abstract.

### FIELD OF TECHNOLOGY

The present disclosure relates to the field of chip design technology, more particularly, to a chip architecture of an isolated converter and an isolated converter.

### BACKGROUND

In isolated flyback switch power supply applications, the secondary side feedback typically uses an error amplifier or a protocol chip to transmit the error signal to the primary side. The primary side utilizes the error signal to implement closed-loop peak current control, thereby adjusting the switching state of the primary power transistor.

In related technologies, components such as the main controller, the secondary controller, and the power transistors are generally designed discretely, resulting in low integration. With the rise of power delivery (PD) technology, there is an increasing demand for highly integrated power supplies. Some related technologies also adopt a chip integration architecture where the main controller and isolated demodulation device are integrated on the same chip, while the secondary controller and isolated modulation device are integrated on the same chip. But the development cost of such chip integration architecture is high, and the flexibility of co-package is limited, making it difficult to meet different application scenarios.

### SUMMARY OF THE DISCLOSURE

The present application provides a chip architecture of an isolated converter and an isolated converter, which solves the technical problems of high development costs and poor co-package flexibility in the primary and secondary side chip integration architectures. Through the chip architecture proposed in the present disclosure, independent designs can be implemented according to different functions, and multiple co-package combinations can be formed. This not only reduces the chip development cost, but also improves the co-package flexibility, greatly improving the applicability to different application scenarios

In order to achieve the above objective, the main technical solutions adopted by the present application comprise:

In a first aspect, embodiments of the present application provide a chip architecture of an isolated converter, comprising a primary side control unit, an isolated communication unit, and a secondary side control unit, wherein,

the primary side control unit comprises a primary side control chip, a primary side drive chip, and a primary side transistor, wherein at least some of the primary side control chip, the primary side drive chip, and the primary side transistor can be designed independently;

the isolated communication unit comprises a primary side demodulation chip and a secondary side modulation chip, which are co-packaged;

the secondary side control unit comprises at least a secondary side main control chip and a secondary side rectification transistor; the secondary side main control chip is configured to control the secondary side rectification transistor and communicate with the primary side control chip through the secondary side modulation chip and the primary side demodulation chip, so as to perform drive control on primary side transistor through the primary side drive chip.

The chip architecture proposed in the present disclosure achieves functional modularization of the chip architecture through independent design of the primary side control unit, the isolated communication unit, and the secondary side control unit. Wherein, at least some of the primary side control chip, the primary side drive chip, and the primary side transistor in the primary side control unit can be independently designed, allowing each functional module to be independently optimized and adapted. The co-package of the primary side demodulation chip and secondary side modulation chip in the isolated communication unit simplifies the hardware structure of isolated communication, enabling independent design according to different functions and forming multiple co-package combinations. Therefore, embodiments of the present application are independently developed and designed based on functional division, and can flexibly set different co-package combinations, which not only greatly improves the applicability and flexibility to different application scenarios, but also avoids repeated development of the same function, shortens the development cycle, and effectively reduces the barrel effect in integrated design compared with the arrangement that the main controller and isolated demodulation device are integrated on the same chip, while the secondary controller and isolated modulation device are integrated on the same chip. Therefore, the embodiments of the present application can greatly reduce the development cost of the chip on the basis of achieving isolated communication between the primary and secondary sides.

Optionally, in some embodiments of the present application, the primary side transistor is fabricated using a high-voltage process, the primary side drive chip is fabricated using a medium-voltage process, and the primary side control chip is fabricated using a low-voltage process.

Optionally, in some embodiments of the present application, the primary side transistor comprises a source, a drain, and a gate, the primary side drive chip comprises a first terminal, a first ground terminal, a first power supply terminal, a current lossless sampling terminal, and a control signal input terminal, and the primary side control chip comprises a second ground terminal, a second power supply terminal, a current sampling terminal, and a control signal output terminal; the first terminal is connected to the source, the first ground terminal is connected to the gate and the second ground terminal, the first power supply terminal is connected to the second power supply terminal, the current lossless sampling terminal is connected to the current sampling terminal, and the control signal input terminal is connected to the control signal output terminal.

Embodiments of the present application connect the corresponding area of the primary side drive chip with the corresponding pins of the primary side transistor and the corresponding area of the primary side control chip. It can control the primary drive chip at low voltage through the primary side control chip, so that the primary side drive chip can drive the primary side transistor with high voltage. This enables the primary side control chip, the primary side drive chip, and the primary side transistor to work together and ensure stable signal transmission.

Optionally, in some embodiments of the present application, when the primary side control chip, the primary side drive chip, and the primary side transistor are integrated into the same package, the package comprises a drain pin, a power supply pin, a current sampling pin, and a ground pin; the drain and the drain pin are connected, the first power supply terminal and the second power supply terminal are connected to the power supply pin, the current lossless sampling terminal and the current sampling terminal are connected to the current sampling pin, and the first ground terminal, the gate, and the second ground terminal are connected to the ground pin.

Optionally, in some embodiments of the present application, where the primary side drive chip and the primary side transistor are designed independently, the primary side transistor adopts a separate power transistor wafer design, and the primary side drive chip is adaptively designed based on the selection of the primary side transistor.

Embodiments of the present application, by the independent design of the primary side drive chip and the primary transistor, enabling the primary side transistor to select the optimal power device according to specific application requirements; meanwhile, the primary side drive chip can be customized for different types of primary side transistors, achieving efficient driving and precise control, and realizing driving functions of high flexibility, low cost, and high reliability.

Optionally, in some embodiments of the present application, in the case of an independently designed primary side control chip, the primary side control chip adopts a low-voltage drive output design, so as to be capable of directly driving transistors with low turn-on threshold voltage.

The primary side control chip proposed in the present disclosure adopts a low-voltage drive output design, which can drive the lower cascaded switches in the depletion type switch, and can also directly drive the transistor with low conduction threshold voltage to improve the direct drive capability of enhanced devices, reduce additional level conversion circuits or complex drive designs, thereby simplifying the system structure and reducing hardware costs.

Optionally, in some embodiments of the present application, the primary side drive chip integrates a switch driving unit, a current lossless sampling unit, and a high-voltage start unit.

Optionally, in some embodiments of the present application, the primary side drive chip is also integrated with a power supply unit.

When there is an external auxiliary winding, a power supply unit is integrated into the primary drive chip to use the electrical energy provided by the external auxiliary winding to power the primary drive chip, improving power supply efficiency and ensuring stable and reliable operation of the primary side drive chip.

Optionally, in some embodiments of the present application, the secondary side control unit further comprises a protocol chip, which is designed independently from the secondary side main control chip.

The independent design of the protocol chip and the secondary side main control chip in this embodiment of the application enables them to be optimized and upgraded separately, thereby reducing development costs, shortening development cycles, and the independently designed protocol chip can more efficiently handle complex communication protocols, ensuring the stability and reliability of data transmission, greatly improving the applicability of isolated converters in PD fast charging application scenarios.

Optionally, in some embodiments of the present application, the primary side control chip, the primary side drive chip, and the primary side transistor can be co-packaged, and the secondary side main control chip and the secondary side rectification transistor are co-packaged.

Embodiments of the present application co-package the primary side control unit, the isolated communication unit, and secondary side control unit separately, making the chip architecture applicable to the layout structure using multiple small printed circuit boards, especially for the application scenario of using planar transformers in PD fast charging.

Optionally, in some embodiments of the present application, the primary side control chip, the primary side drive chip, the primary side transistor, the primary side demodulation chip, the secondary side modulation chip, the secondary side main control chip, and the secondary side rectification transistor are co-packaged, while the protocol chip is separately packaged.

Optionally, in some embodiments of the present application, the primary side control chip, the primary side drive chip, the primary side transistor, the primary side demodulation chip, the secondary side modulation chip, the secondary side main control chip, the secondary side rectification transistor, and the protocol chip are co-packaged.

Embodiments of the present application co-package the primary side control unit, the isolated communication unit, and the secondary side control unit, and can choose to package the protocol chip separately or co-package the protocol chip as well, making the chip architecture highly integrated and particularly suitable for the application scenario of using winding transformers in PD fast charging, meeting the requirements for high integration and compact layout, greatly improving the integration and power density of the chip architecture.

Optionally, in some embodiments of the present application, the primary side control chip, the primary side drive chip, the primary side transistor, the primary side demodulation chip, the secondary side modulation chip, and the secondary side main control chip are co-packaged, while the secondary side rectification transistor is separately packaged.

Embodiments of the present application separately packages the secondary side rectification transistor, and co-package other parts of the primary side control unit, the isolated communication unit, and the secondary side control unit, making the chip architecture highly integrated and particularly suitable for industrial and electric vehicle non-PD application scenarios.

In a second aspect, embodiments of the present application provide an isolated converter, comprising:

a transformer;

the chip architecture of the isolated converter according to the above embodiments.

The isolated converter proposed in the embodiments of the present application achieves a chip architecture with functional modularization, enabling independent optimization and adaptation of each functional module. This allows for corresponding independent design according to different functions and the formation of various co-package combinations. Therefore, embodiments of the present disclosure are independently developed and designed based on functional division, and can be flexibly configured with different co-package combinations. This not only greatly enhances the applicability and flexibility for different application scenarios, but also avoids redundant development of the same functions, shortens the development cycle, and effectively reduces the "cask effect" in integration design compared with the arrangement that the main controller and isolated demodulation device are integrated on the same chip, while the secondary controller and isolated modulation device are integrated on the same chip. As a result, it can significantly reduce the development cost of chips while achieving isolated communication between the primary and secondary sides.

### BRIEF DESCRIPTION OF THE DRAWINGS

To illustrate the specific embodiments of the present application or the technical solutions in the prior art more clearly, the accompanying drawings required for the description of the specific embodiments or prior art will be briefly introduced below. It is obvious that the accompanying drawings described below are some embodiments of the present application. For those skilled in the art, other accompanying drawings can be obtained based on these accompanying drawings without creative effort.

FIG. 1 is a schematic diagram of a circuit structure of an isolated flyback switch power supply in related technology;

FIG. 2 is a schematic diagram of another circuit structure of an isolated flyback switch power supply in related technology;

FIG. 3 is a structural schematic diagram of the chip architecture of the isolated converter proposed in an embodiment of the present application;

FIG. 4A is a structural schematic diagram of the primary side drive chip proposed in an embodiment of the present application;

FIG. 4B is a structural schematic diagram of the primary side drive chip proposed in another embodiment of the present application;

FIG. 5 is a structural schematic diagram of the primary side drive chip proposed in another embodiment of the present application;

FIG. 6A is a schematic diagram of the connection structure of the chip architecture proposed in in an embodiment of the present application;

FIG. 6B is a schematic diagram of the connection structure of the chip architecture proposed in in another embodiment of the present application;

FIG. 7 is a schematic diagram of a co-package method of the chip architecture proposed in an embodiment of the present application;

FIG. 8 is a schematic diagram of a co-package method of the chip architecture proposed in another embodiment of the present application;

FIG. 9 is a schematic diagram of a co-package method for chip architecture proposed in still another embodiment of the present application;

FIG. 10 is a schematic diagram of a co-package method of the chip architecture proposed in a further embodiment of the present application.

### DETAILED DESCRIPTION OF THE DISCLOSURE

To make the objectives, technical solutions, and advantages of the embodiments of the present disclosure clearer, the technical solutions in the embodiments of the present disclosure will be described clearly and comprehensively below in conjunction with the accompanying drawings. Obviously, the described embodiments are a part of the embodiments of the present disclosure, not all of them. Based on the embodiments in the present disclosure, all other embodiments obtained by those skilled in the art without creative effort fall within the protection scope of the present disclosure.

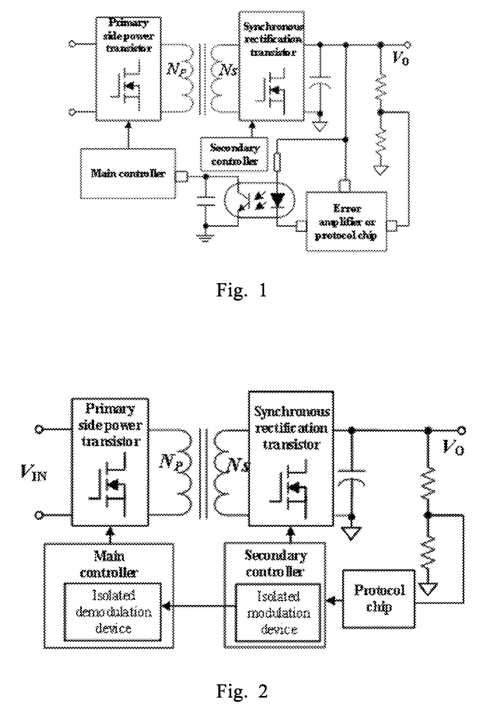

In the application of isolated flyback switch power supplies, as shown in FIG. 1, the primary controller is set on the primary side to control the on and off states of the primary power transistor. When the primary power transistor is turned on, the input voltage V_{IN} charges the primary winding Nₚ of the transformer, and the transformer stores energy. The transformer transfers the primary energy to the secondary winding Ns, and the secondary side obtains an error signal by sampling the output voltage Vo. The secondary side feedback generally uses an error amplifier or protocol chip to transmit the sampled error signal to the primary side. The primary side implements closed-loop peak current control through the error signal, thereby adjusting the switching state of the primary power transistor.

To improve efficiency, the secondary side transistor can utilize a synchronous rectification switch and configure a secondary controller (SR Controller) to control. In some related technologies, components such as the main controller, the secondary controller, and transistor are typically designed discretely, resulting in low integration. With the rise of PD fast charging technology, which can be widely applied to various electronic devices, such as mobile phones, tablets, and laptops, PD fast charging technology, also known as the USB Power Delivery protocol, is based on Type-C interface and has robust voltage regulation capabilities. It can provide multiple voltage outputs ranging from 5V to 20V, adapting to the charging needs of different devices. This protocol not only supports higher power transmission, with a maximum of 100W or even higher, significantly reduces charging time, but also boasts a comprehensive safety protection mechanism, including overvoltage, overcurrent, and overheat protection, ensuring a safe and reliable charging process.

Since PD fast charging power delivery devices are typically used in portable electronic devices such as smartphones, laptops, and tablets, which have strict requirements on size and weight, the power module needs to be as compact and lightweight as possible. Additionally, PD technology requires support for multiple voltage and current outputs to dynamically adjust output power according to device needs. This complex power management function requires multiple functional modules to work together, and a highly integrated power supply layout can optimize signal transmission paths, thereby improving system response speed and control accuracy. Therefore, a discrete design of an isolated flyback switch power supply is difficult to meet the demand for highly integrated power supplies in fast charging technologies such as PD.

In some other related technologies, as shown in FIG. 2, a chip integration architecture where the main controller and isolated demodulation device are integrated on the same chip, while the secondary controller and isolated modulation device are integrated on the same chip is adopted, i.e., the main controller and isolated demodulation device are co-die designed, and the secondary controller and isolated modulation device are co-die designed. However, due to the different numbers of mask layers required for the isolated components and the control circuit, and the constraints imposed by the requirements of the isolated components, the primary and secondary side must be co-packaged. This results in devices with fewer mask layers having to accommodate devices with more mask layers, creating a "cask effect". This makes the development cost of this chip integration architecture higher, and the co-package flexibility is poorer, making it difficult to meet different application scenarios.

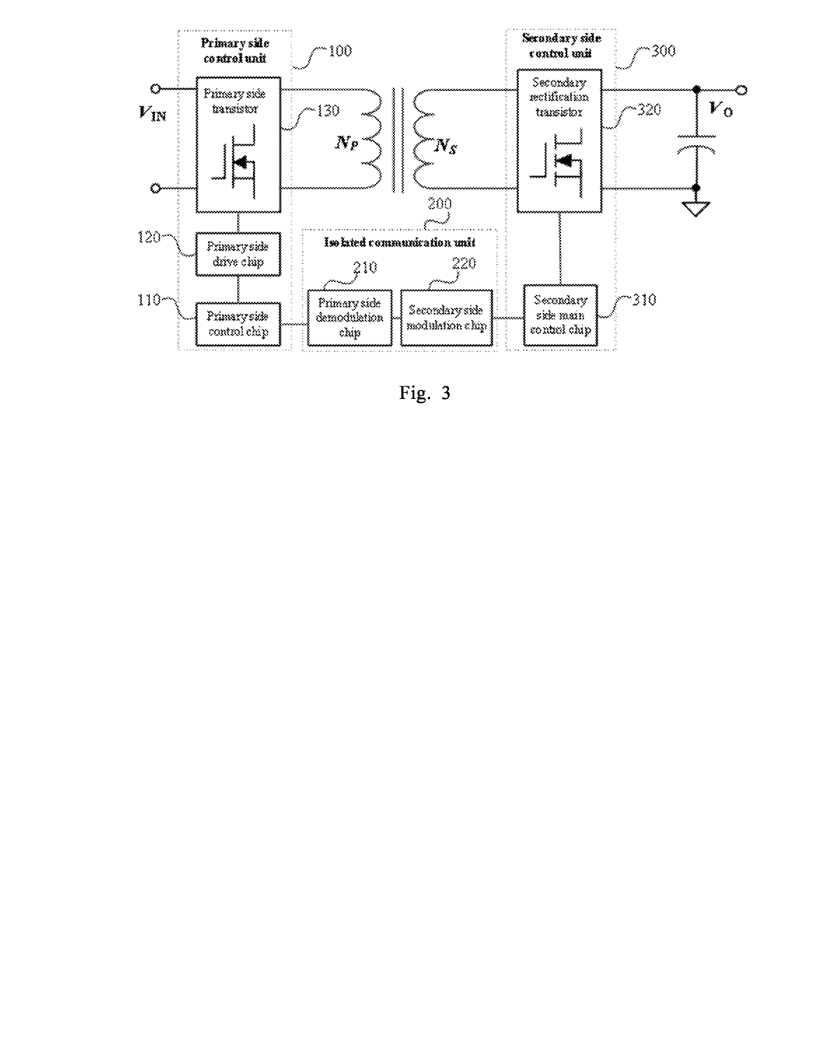

Embodiments of the present application provide a chip architecture for an isolated converter, which can be used in PD power supplies for portable electronic devices such as smartphones, laptops, and tablet computers, as well as in power supply devices for industrial equipment and electric vehicles that do not support PD fast charging applications. As shown in FIG. 3, the chip architecture comprises a primary side control unit 100, an isolated communication unit 200, and a secondary side control unit 300. The primary side control unit 100 comprises a primary side control chip 110, a primary side drive chip 120, and a primary side transistor 130. At least some of these components can be designed independently. The isolated communication unit 200 comprises a primary side demodulation chip 210 and a secondary side modulation chip 220, which are co-packaged. The secondary side control unit 300 at least comprises a secondary side main control chip 310 and a secondary side rectification transistor 320. The secondary side main control chip 310 is configured to control the secondary side rectification transistor 320 and communicate with the primary side control chip 110 through the secondary side modulation chip 220 and the primary side demodulation chip 210, so as to perform drive control on primary transistor130 through the primary drive chip 120.

Embodiments of the present application are divided according to the functional modules of the isolated converter, and a chip architecture comprising a primary side control unit 100, an isolated communication unit 200, and a secondary side control unit 300 is constructed. The primary side control chip 110, primary side drive chip 120, and primary side transistor 130 in the primary side control unit 100 can be independently designed according to the requirements of practical applications, so as to facilitate corresponding development based on different needs. This is conducive to the individual optimization of the primary side control chip 110, primary drive chip 120, and primary transistor 130, reducing redundant development of functional modules.

The primary side control chip 110 is responsible for controlling the on and off of the primary side transistor 130, thereby regulating the energy storage and release process of the primary winding Nₚ of the transformer. Since the signal output by the primary side control chip 110 typically has low power and cannot directly drive the primary side transistor to turn on and off quickly and reliably, the control signal output by the primary side control chip is amplified and level-converted by the primary side drive chip 120 to meet the driving requirements of the primary side transistor.

Embodiments of the present application also co-package the primary side demodulation chip 210 and the secondary side modulation chip 220 to achieve communication between the primary and secondary sides. This not only meets the integration requirements of isolated devices, but also achieves independent design of the isolated communication function module and the primary and secondary side control units. The primary side demodulation chip 210 and the secondary side modulation chip 220 work together to transmit the feedback signal from the secondary side to the primary side, enabling the primary side control chip 110 to output corresponding control signals based on the feedback signal.

Generally, isolated devices use capacitive isolated technology and need two chips to be interconnected and communicate through wire bonding. During communication, the secondary side main control chip 310 transmits feedback signals to the secondary side modulation chip 220, which then passes the signals through capacitive isolated communication to the primary side demodulation chip 210, which demodulates the feedback signals and then transmits to the primary side control chip 110. Due to the design that the primary side demodulation chip 210 and the secondary side modulation chip 220 use two dies, and they must perform co-package through wire bonding, if the primary side control chip 110 and the primary side demodulation chip 210 are co-die designed, and the secondary side main control chip 310 and the secondary side modulation chip 220 are co-die designed, it will reduce the flexibility of the co-package method and increase the integration cost.

It should be noted that in some embodiments of the present application, the isolated communication unit 200 can also comprise the co-packaged primary side modulation chip and the secondary side demodulation chip, so as to transmit the control instructions output by the primary side control chip 110 to the secondary side, so as to adjust the operating state of the entire isolated converter. Therefore, the isolated communication unit 200 proposed in the embodiments of the present application can achieve primary-secondary communication, thereby reducing the risk of common communication between the primary and secondary sides.

In addition, in the embodiments of the present application, a resistive voltage divider network is set up at the output terminal on the secondary side to sample the output voltage Vo of the isolated converter, and the sampled signal is sent as a feedback signal to the secondary side main control chip 310. On the one hand, the secondary side main control chip 310 controls the secondary side rectification transistor 320 based on the feedback signal, enabling the secondary side rectification transistor 320 to turn on and off at appropriate times, thereby controlling the energy storage and release process of the transformer secondary winding Ns to adjust the output voltage and current. On the other hand, the feedback signal is transmitted to the primary side demodulation chip 210 through the secondary side modulation chip 220 to achieve communication between the primary and secondary sides, thereby achieving electrical isolated and power conversion.

In summary, the chip architecture provided in this embodiment achieves a functional modularization through the independent design of the primary side control unit 100, the isolated communication unit 200, and the secondary side control unit 300. At least some of the primary side control chip 110, primary side drive chip 120, and primary side transistor 130 in the primary side control unit 100 can be independently designed, enabling independent optimization and adaptation of each functional module. Additionally, the primary side demodulation chip 210 and secondary side modulation chip 220 in the isolated communication unit 200 are co-packaged, simplifying the hardware structure of isolated communication. This allows for corresponding independent designs according to different functions and enables the formation of various co-package combinations. Therefore, embodiments of the present application are independently developed and designed based on functional division, and can flexibly set different co-package combinations. This not only greatly improves the applicability and flexibility for different application scenarios, but also avoids redundant development of the same function, shortens the development cycle, and effectively improves the cask effect in the integrated design compared with the arrangement that the main controller and isolated demodulation device are integrated on the same chip, while the secondary controller and isolated modulation device are integrated on the same chip. Thus, it can significantly reduce the development cost of the chip while achieving isolated communication between the primary and secondary sides.

Furthermore, in some embodiments of the present application, when the primary side drive chip 120 and the primary side transistor 130 are designed independently, the primary side transistor 130 uses separate power transistor wafer design, and the primary side drive chip 120 is adaptively designed based on the selection of the primary transistor 130.

Therefore, the embodiments of the present application, through the independent design of the primary side drive chip 120 and the primary side transistor 130, enable the primary side transistor 130 to select the optimal power device according to specific application requirements, while the primary side drive chip 120 can be customized for different types of primary side transistors 130, thereby achieving efficient driving and precise control, as well as high flexibility, low cost, and high reliability of the driving function.

Specifically, the primary side transistor 130 is a depletion-mode device, including at least one of a depletion-mode Metal-Oxide-Semiconductor Field-Effect Transistor (D-mode MOSFET), a depletion-mode Gallium Nitride (D-mode GaN), an enhancement-mode Gallium Nitride (E-mode GaN), and a Silicon Carbide Junction Field-Effect Transistor (SiC JFET). The primary side drive chip 120 can be adapted according to different depletion-mode device types.

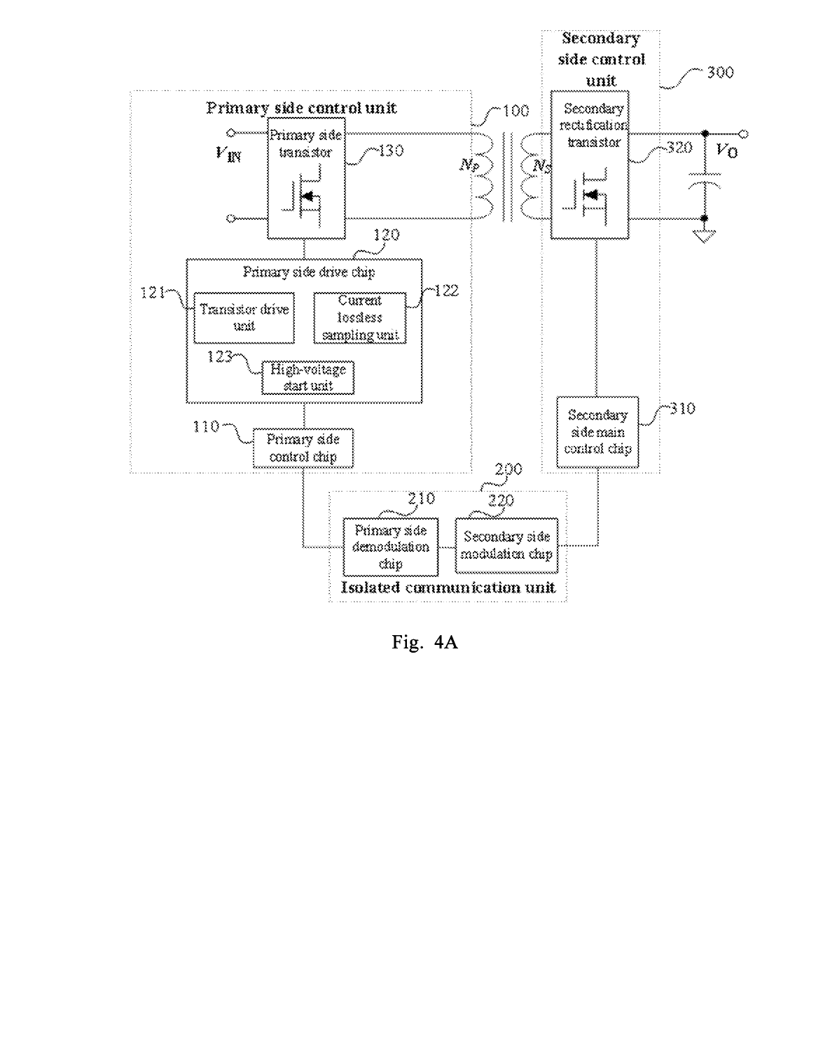

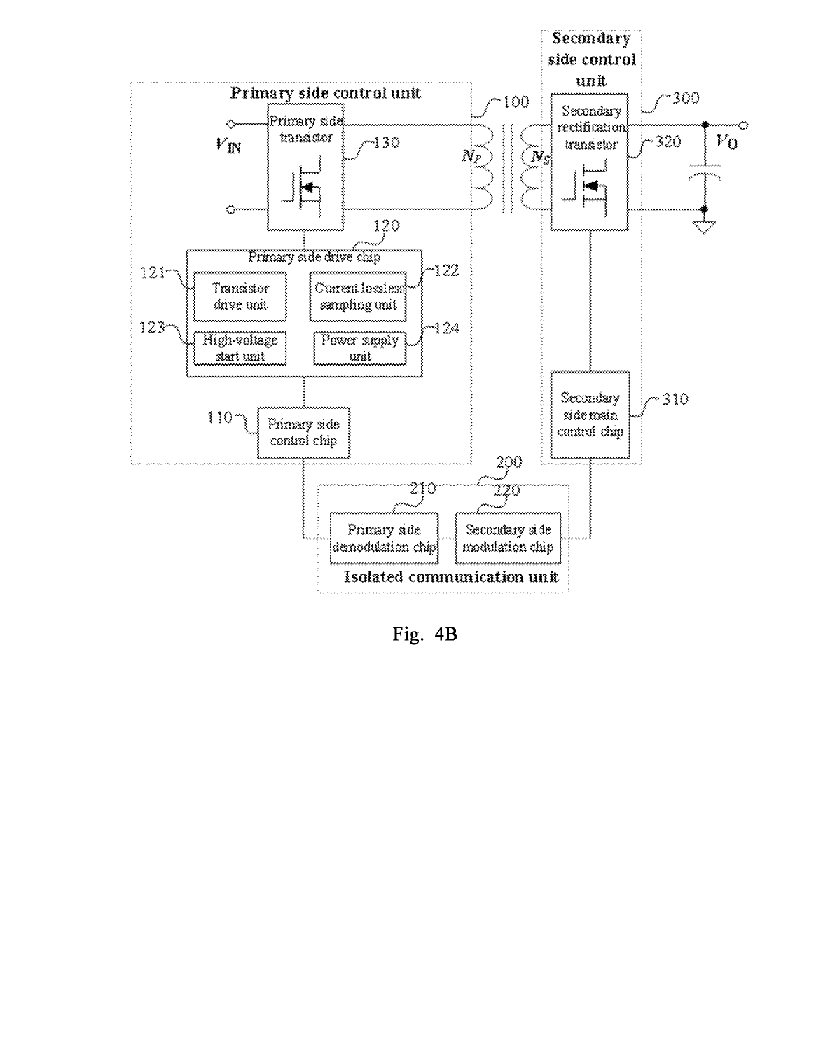

In some embodiments of the present application, as shown in FIG. 4A, the primary-side drive chip 120 integrates a transistor drive unit 121, a current lossless sampling unit 122, and a high-voltage startup unit 123

Wherein, due to the use of a cascode drive structure in depletion-mode devices, the transistor drive unit 121 needs to integrate a lateral double-diffused metal-oxide-semiconductor (LDMOS) with a voltage rating of around 30V as the lower transistor in the cascode drive structure. For primary side transistor 130 with different on-resistance Rds, drive chips with LDMOS of different impedances can be designed for adaptive combination. In addition, since the main power current of the primary side control unit 100 can flow through the LDMOS lower transistor, a current sampling transistor can be integrated on the LDMOS to construct a current lossless sampling unit 122, and a current lossless sampling pin CS is provided to achieve lossless sampling of the main power current.

It should be noted that when the primary side transistor 130 is a depletion-mode device, a high-voltage startup unit 123 can be integrated into the primary side drive chip 120 through multi-switch multiplexing, to enable the transistor drive unit 121 to drive the primary transistor 130.

Furthermore, in some embodiments of the present application, when the primary side control chip 110 is designed independently, it adopts a low-voltage drive output design, so as to be capable of directly driving transistors with low turn-on threshold voltage.

This is because the transistor drive unit 121 uses LDMOS, and it has a relatively low turn-on threshold voltage. At this time, only the primary side control chip 110 needs to provide low-voltage driving. It should be noted that in order to accommodate the primary side transistor 130 using enhanced devices such as E-mode GaN, the driving output of the primary side control chip 110 can be at a level of 6.5V.

Therefore, the primary side control chip 110 proposed in the embodiments of the present disclosure adopts a low-voltage drive output design, which can also directly drive transistors with low turn-on threshold voltage, thereby enhancing the direct drive capability for enhanced devices. This allows the primary-side control chip 110 to use low-voltage processes within 10V, reducing the need for additional level conversion circuits or complex drive designs, thus simplifying the system structure and reducing hardware costs.

It should be noted that as shown in FIG. 4B, in some embodiments of the present application, the power generated by the high-voltage startup unit 123 can be directly used to power the primary side control chip 110; or a power supply unit 124 can be integrated into the primary side drive chip 120, and the primary side control chip 110 can be powered through the power supply unit 124.

When there is an external auxiliary winding, the power supply unit 124 is integrated into the primary side drive chip to utilize the electric energy provided by the external auxiliary winding to power the primary side drive chip, thereby improving the power supply efficiency and ensuring that the primary side drive chip can operate stably and reliably.

In some embodiments of the present application, the primary side control chip 110 comprises at least one of a pulse width modulation (PWM) control chip, a quasi resonant (QR) control chip, and a zero voltage switch (ZVS) control chip.

Since at least some of the primary side control chip 110, primary side drive chip 120, and primary side transistor 130 can be designed independently, in the embodiments of the present application, the primary side control unit 100 can include various combinations, such as:

Combination 1: a combination utilizing SiC JFET as the primary side transistor 130, a PWM control chip as the primary side control chip 110, and a primary side drive chip 120;

Combination 2: a combination utilizing SiC JFET as the primary side transistor 130, QR control chip as the primary side control chip 110, and primary side drive chip 120;

Combination 3: a combination utilizing SiC JFET as the primary side switch 130, ZVS control chip as the primary side control chip 110, and primary side drive chip 120;

Combination 4: a combination utilizing D-mode GaN as the primary side switch 130, using a PWM control chip as the primary side control chip 110, and using a primary side drive chip 120;

Combination 5: a combination utilizing D-mode GaN as the primary side transistor 130, a QR control chip as the primary side control chip 110, and a primary side drive chip 120;

Combination 6: a combination utilizing D-mode GaN as the primary side transistor 130, a ZVS control chip as the primary side control chip 110, and a primary side drive chip 120;

Combination 7: a combination utilizing a D-mode MOSFET as the primary side transistor 130, a PWM control chip as the primary side control chip 110, and a primary side drive chip 120;

Combination 8: a combination utilizing a D-mode MOSFET as the primary side switch 130, a QR control chip as the primary side control chip 110, and a primary side drive chip 120;

Combination 9: a combination utilizing a D-mode MOSFET as the primary side transistor 130, a ZVS control chip as the primary side control chip 110, and a primary side drive chip 120.

It can be seen that the embodiments of the present application can flexibly construct the device selection and combination of the primary side control chip, the primary side drive chip, and the primary side transistor according to the actual application needs, thereby correspondingly developing the required chips, avoiding repeated development, and facilitating the optimization and upgrading of individual functional chips. This can improve development efficiency and success rate, greatly reducing chip development costs. For example, if it is necessary to upgrade the primary side control chip 110, it only needs to redevelop the primary side control chip 110 separately, and other functional modules of the primary side control unit 100 can be fully reused. This facilitates product serialization and reduces the corresponding iteration and upgrade risks. In addition, compared with the design where the primary side driver and the primary side controller are integrated on the same chip, i.e., the primary side driver and the primary side controller are co-die designed, the embodiments of the present application can separate the functions of the primary side control and the primary side drive, which can reduce the models of the controllers, facilitate the inventory normalization of the primary side control chip 110, and reduce costs to a certain extent.

As shown in FIG. 4, embodiments of the present application achieves primary side secondary communication through the primary side demodulation chip 210 and the secondary side modulation chip 220. To achieve high speed communication, isolated devices usually require more mask layers, while control devices usually require fewer mask layers, and the chip area of control devices is generally larger than that of isolated devices. Therefore, compared with the existing solution that the isolated devices and control devices are co-die designed, embodiments of the present application integrate the isolated communication unit 200 separately, effectively improving the cask effect, reducing the number of mask layers, and thereby significantly reducing chip development costs.

It should be noted that the isolated communication unit 200 can also comprises a primary side modulation chip and a secondary side demodulation chip. Compared with using optocoupler feedback, this not only extends the lifespan of the device and improves its reliability, but also enables bidirectional communication between the primary side and secondary side, effectively avoiding common communication risk between the primary side and secondary side.

In some embodiments of the present application, the secondary side main control chip 310 receives feedback signals from the secondary side to control the secondary side rectification switch 320. The secondary side main control chip 310 comprises at least one of a PWM control chip, a QR control chip, and a ZVS control chip.

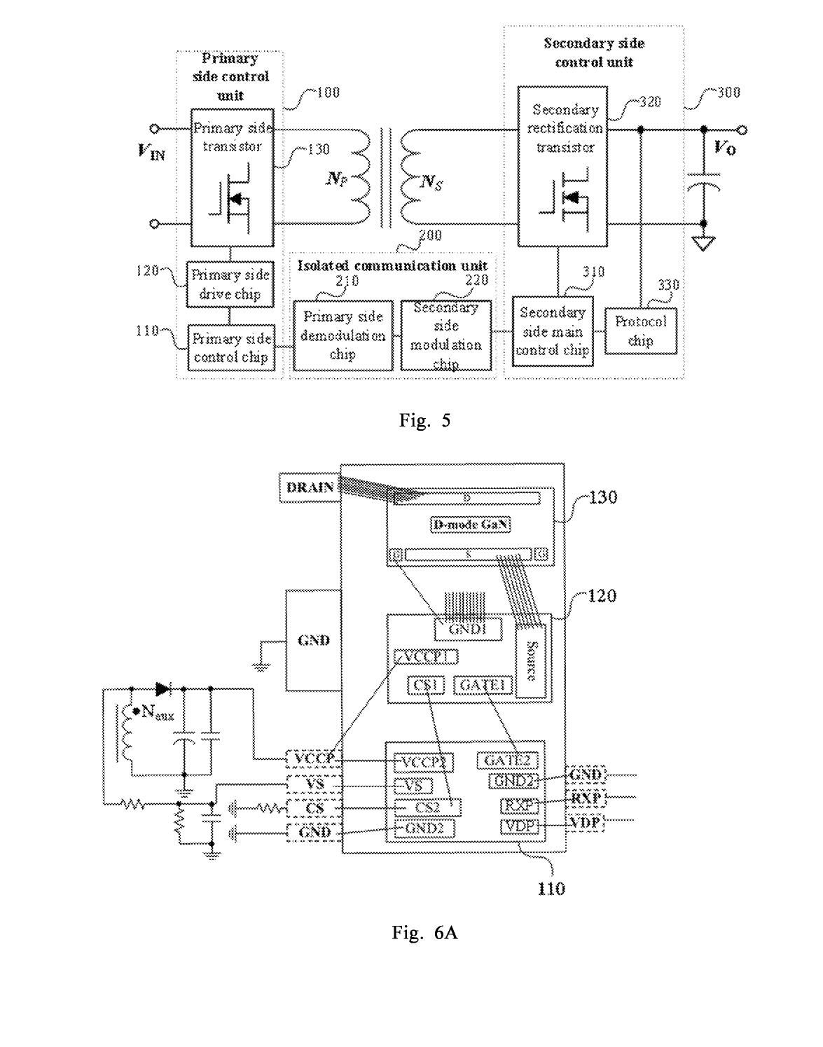

As shown in FIG. 5, in some embodiments of the present application, the secondary side control unit 300 further comprises a protocol chip 330, which is designed separately from the secondary side main control chip 310.

It should be noted that the protocol chip 330 is only used in PD application scenarios for communication through the Power Delivery (USB PD) protocol. Furthermore, in some embodiments of the present disclosure, the protocol chip 330 can integrate an error amplifier and a closed-loop reference circuit to satisfy the non-PD fast charging application scenarios.

Therefore, the independent design of the protocol chip 330 and the secondary side main control chip 310 in the embodiments of the present disclosure enables both to be optimized and upgraded separately, thereby reducing development costs and shortening development cycles. Moreover, the independently designed protocol chip 330 can process complex communication protocols more efficiently, ensuring the stability and reliability of data transmission, greatly improving the applicability of the isolated converter in PD fast charging application scenarios.

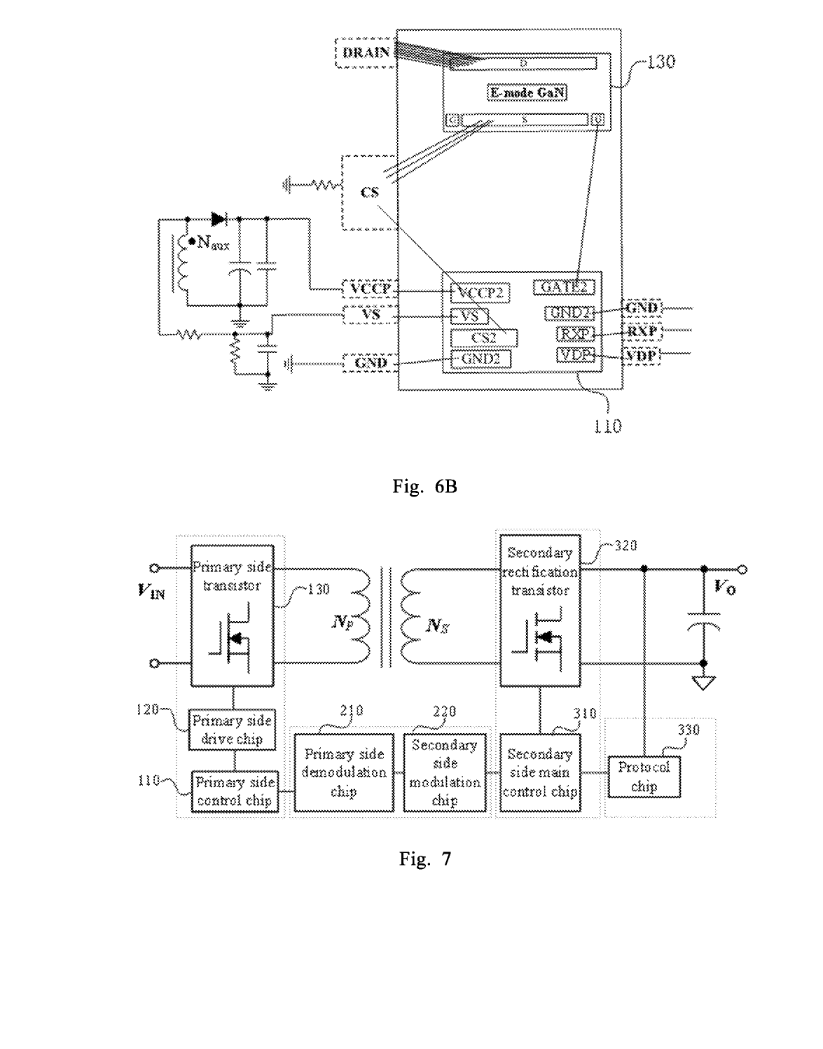

Specifically, as shown in FIG. 6A, in some embodiments of the present application, the primary side transistor 130 is fabricated using a high-voltage process, the primary side drive chip 120 is fabricated using a medium-voltage process, and the primary side control chip 110 is fabricated using a low-voltage process.

That is to say, in some examples of the present application, the voltage resistance of the aforementioned primary side transistor 130 can be above 400V, e.g., 650V. The voltage resistance of the lower cascaded switch of the depletion transistor in the aforementioned primary side drive chip 120 can be selected as 30V. The operating voltage of the aforementioned primary side control chip 110 can be within 10V, such as 6.5V. This can meet the requirement of directly driving switches with low turn-on threshold voltage.

Furthermore, the primary side transistor 130 comprises a source terminal S, a drain terminal D, and a gate terminal G. The primary side drive chip 120 comprises a first terminal Source, a first ground terminal GND1, a first power supply terminal VCCP1, a current lossless sampling terminal CS1, and a control signal input terminal GATE1. The primary side control chip 110 comprises a second ground terminal GND2, a second power supply terminal VCCP2, a current sampling terminal CS2, and a control signal output terminal GATE2.

As shown in FIG. 6A, when the primary side transistor 130 is a depletion-mode device such as D-mode GaN, If the primary side control chip 110, primary driver chip 120, and primary transistor 130 are co-packaged, that is to say, if the primary side control chip 110, the primary side drive chip 120, and the primary side transistor 130 are integrated into the same package, the package including primary side control chip 110, primary driver chip 120, and primary transistor 130 comprises a drain pin DRAIN, a power supply pin VCCP, a current sampling pin CS, and a ground pin GND. The drain terminal D is connected to the drain pin DRAIN, the first power supply terminal VCCP1 and the second power supply terminal VCCP2 are connected to the power supply pin VCCP, the current lossless sampling terminal CS1 and the current sampling terminal CS2 are connected to the current sampling pin CS, and the first ground terminal GND1, gate G, and the second ground terminal GND2 are connected to the ground pin GND.

The first terminal Source is connected to the source terminal S; the first ground terminal GND1 is connected to the gate terminal G and the second ground terminal GND2; the first power supply terminal VCCP1 is connected to the second power supply terminal VCCP2, the current lossless sampling terminal CS1 is connected to the current sampling terminal CS2, and the control signal input terminal GATE1 is connected to the control signal output terminal GATE2.

In addition, the primary side control chip 110 also comprises a detection terminal VS, a receiving terminal RXP, and a third power supply terminal VDP. The detection terminal VS is used to perform voltage detection on the external auxiliary winding Naux, the receiving terminal RXP is used to receive the feedback signals from the primary demodulation chip 210, and the third power supply terminal VDP1 is used to power the primary side demodulation chip 210.

It should be noted that in other embodiments of the present application, as shown in FIG. 6B, when the primary transistor 130 is an E-mode GaN or other enhancement-mode device, the primary side control chip 110 can output a voltage level of 6.5V to directly drive the primary side transistor 130 through the control signal output terminal GATE2.

Specifically, the source terminal S of the primary side transistor 130 is connected to the current sampling terminal CS2 of the primary side control chip 110. The primary side control chip 110 outputs a control signal through the control signal output terminal GATE2. The gate terminal G of the primary side transistor 130 receives the control signal and drives the primary side transistor 130 to turn on through the drive level output by the control signal output terminal GATE2. The drain terminal D of the primary side transistor 130 is connected to the primary winding N_{P} through the drain pin DRAIN, thereby controlling the energy storage and release of the primary winding N_{P} through the turning on and off of the primary side transistor 130.

In addition, in some embodiments of the present application, the secondary side main control chip 310 generates a feedback signal on the secondary side, and then sends the feedback signal to the primary side control chip 110 through the secondary side modulation chip 220 and the primary side demodulation chip 210, thereby achieving isolated communication between the primary side control chip 110 and the secondary side main control chip 310.

The secondary side main control chip 310 is also connected to the corresponding pins of the protocol chip 330 to achieve protocol communication. Thus it can be seen that the embodiments of the present application can independently develop and design various functions according to specific needs, such as separately developing corresponding control functions, drive functions, and transistor functions for the primary and secondary sides, and separately integrating the primary side demodulation chip 210 and the secondary side modulation chip 220 to expand different co-package combinations between the primary side control unit 100, the isolated communication unit 200, and the secondary side control unit 300. The following describes some co-package combinations in the embodiments of the present application and their applicable application scenarios.

As shown in FIG. 7, in some embodiments of the present application, the primary side control chip 110, the primary side drive chip 120, and the primary side transistor 130 can be co-packaged, while the secondary side main control chip 310 and the secondary side rectification transistor 320 are co-packaged, and the protocol chip 330 is separately packaged.

Specifically, in this embodiment, the primary control unit 100, the isolated communication unit 200, and the secondary control unit 300 are each co-packaged to a certain degree, but not highly integrated. Therefore, the chip architecture can be adapted to a panel structure using multiple small printed circuit boards, especially for application scenarios involving planar transformers in PD fast charging.

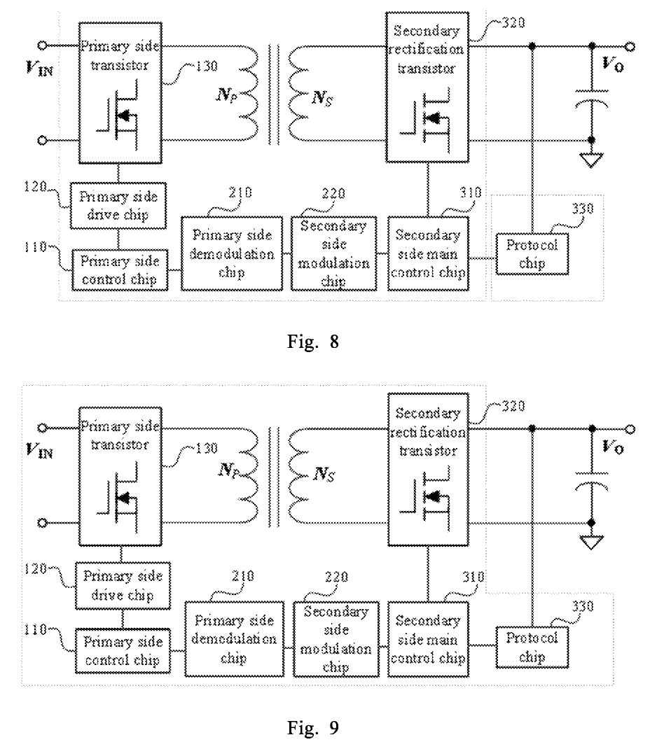

As shown in FIG. 8, in some embodiments of the present application, the primary side control chip 110, the primary side drive chip 120, the primary side transistor 130, the primary side demodulation chip 210, the secondary side modulation chip 220, the secondary side main control chip 310, and the secondary side rectification transistor 320 are co-packaged, while the protocol chip 330 is separately packaged.

Specifically, in this embodiment, all components in the isolated converter, except the protocol chip 330, are co-packaged, to achieve a high level of integration. Therefore, the chip architecture is suitable for application scenarios using wire-wound transformers in PD fast charging.

As shown in FIG. 9, in some embodiments of the present application, the primary side control chip 110, the primary side drive chip 120, the primary side transistor 130, the primary side demodulation chip 210, the secondary side modulation chip 220, the secondary side main control chip 310, the secondary side rectification transistor 320, and the protocol chip 330 are co-packaged.

Specifically, compared with the embodiment shown in FIG. 8, this embodiment has higher integration, making the chip architecture equally suitable for application scenarios involving the use of wire-wound transformers in PD fast charging.

Therefore, in the embodiments of the present application, the primary side control unit 100, the isolated communication unit 200, and the secondary side control unit 300 are all co-packaged. Additionally, the protocol chip 330 can be packaged separately or co-packaged, resulting in a highly integrated chip architecture. This architecture is particularly suitable for application scenarios involving the use of wire-wound transformers in PD fast charging, meeting the requirements for high integration and compact layout, and greatly improving the integration and power density of the chip architecture.

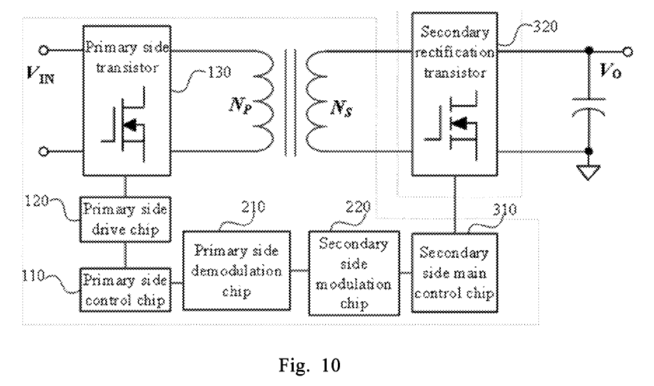

As shown in FIG. 10, in some embodiments of the present application, the primary side control chip 110, the primary side drive chip 120, the primary side transistor 130, the primary side demodulation chip 210, the secondary side modulation chip 220, and the secondary side main control chip 310 are co-packaged, while the secondary side rectification transistor 320 is separately packaged.

In the embodiment of the present disclosure, the secondary side transistor 320 is separately packaged, while the primary side control unit 100, the isolated communication unit 200, and other components of the secondary side control unit 300 are co-packaged, resulting in a highly integrated chip architecture. Furthermore, the protocol chip 330 is not integrated, making it particularly suitable for industrial and electric vehicle applications in non-PD fast charging scenarios.

Correspondingly, embodiments of the present application provide an isolated transformer, including a transformer, and the chip architecture of the isolated transformer according to the above embodiments.

The further functional descriptions of the above-mentioned modules and units are identical to those in the corresponding embodiments mentioned above, and will not be repeated here.

The isolated converter proposed in the present application implements a chip architecture of functional modularization, allowing each functional module to be independently optimized and adapted, thereby achieving corresponding independent designs according to different functions and forming multiple co-package combinations. Therefore, embodiments of the present application are independently developed and designed based on functional division, and can flexibly set different co-package combinations, which not only greatly improves the applicability and flexibility for different application scenarios, but also avoids repeated development of the same function, shortens the development cycle, and effectively reduces the cask effect in integrated design compared with the arrangement that the main controller and isolated demodulation device are integrated on the same chip, while the secondary controller and isolated modulation device are integrated on the same chip. Therefore, embodiments of the present application can greatly reduce the development cost of the chip on the basis of achieving isolated communication between the primary side and secondary side.

For the convenience of description, the above devices are divided into various functional units and described separately. Of course, the functions of each unit can be implemented in the same or multiple software and/or hardware when implementing the present application.

It should also be noted that the terms “comprise”, “include”, “containing” or any other variation thereof are intended to encompass non-exclusive inclusion, such that the process, method, good or equipment that includes a series of elements not only includes those elements, but also includes other elements not explicitly listed, or also includes elements inherent to such process, method, good or equipment. Without further limitations, the element defined by the statement “including one...” does not exclude the existence of other identical elements in the process, method, product, or device that includes the element in question.

The various embodiments in this manual are described in a progressive manner, and the same and similar parts between each embodiment can be referred to each other. What is focused in each embodiment is different from those in other embodiments.

The above description is only embodiments of the present application and is not intended to limit the present application. For those skilled in the art, the present disclosure may have various modifications and variations. Any modifications, equivalent substitutions, improvements, etc. made within the spirit and principles of the present disclosure shall be included within the scope of the claims of the present application.

Although the embodiments of the present application have been described in conjunction with the accompanying drawings, those skilled in the art may make various modifications and variations without departing from the spirit and scope of the present application, and such modifications and variations fall within the scope defined by the appended claims.

What is claimed is:

1. A chip architecture of an isolated converter, comprising a primary side control unit, an isolated communication unit, and a secondary side control unit, wherein,
the primary side control unit comprises a primary side control chip, a primary side drive chip, and a primary side transistor, wherein at least one of the primary side control chip, the primary side drive chip, and the primary side transistor is structured to enable designed independently;
the isolated communication unit comprises a primary side demodulation chip and a secondary side modulation chip, which are co-packaged;
the secondary side control unit comprises at least a secondary side main control chip and a secondary side rectification transistor; the secondary side main control chip is configured to control the secondary side rectification transistor and communicate with the primary side control chip through the secondary side modulation chip and the primary side demodulation chip, so as to perform drive control on the primary side transistor through the primary side drive chip.

2. The chip architecture of the isolated converter of claim 1, wherein the primary side transistor is fabricated using a high-voltage process, the primary side drive chip is fabricated using a medium-voltage process, and the primary side control chip is fabricated using a low-voltage process.

3. The chip architecture of the isolated converter of claim 1, wherein the primary side transistor comprises a source, a drain, and a gate, the primary side drive chip comprises a first terminal, a first ground terminal, a first power supply terminal, a current lossless sampling terminal, and a control signal input terminal, and the primary side control chip comprises a second ground terminal, a second power supply terminal, a current sampling terminal, and a control signal output terminal; the first terminal is connected to the source, the first ground terminal is connected to the gate and the second ground terminal, the first power supply terminal is connected to the second power supply terminal, the current lossless sampling terminal is connected to the current sampling terminal, and the control signal input terminal is connected to the control signal output terminal.

4. The chip architecture of the isolated converter of claim 3, wherein when the primary side control chip, the primary side drive chip, and the primary side transistor are integrated into a same package, the package comprises a drain pin, a power supply pin, a current sampling pin, and a ground pin; the drain and the drain pin are connected, the first power supply terminal and the second power supply terminal are connected to the power supply pin, the current lossless sampling terminal and the current sampling terminal are connected to the current sampling pin, and the first ground terminal, the gate, and the second ground terminal are connected to the ground pin.

5. The chip architecture of the isolated converter of claim 1, wherein, where the primary side drive chip and the primary side transistor are designed independently, the primary side transistor adopts a separate power transistor wafer design, and the primary side drive chip is adaptively designed based on the selection of the primary side transistor.

6. The chip architecture of the isolated converter of claim 1, wherein in the case of an independently designed primary side control chip, the primary side control chip adopts a low-voltage drive output design, so as to be capable of directly driving transistors with low turn-on threshold voltage.

7. The chip architecture of the isolated converter of claim 1, wherein the primary side drive chip is integrated with a transistor drive unit, a current lossless sampling unit, and a high-voltage startup unit.

8. The chip architecture of the isolated converter of claim 7, wherein the primary side drive chip is also integrated with a power supply unit.

9. The chip architecture of the isolated converter of claim 1, wherein the secondary side control unit further comprises a protocol chip, designed independently from the secondary side main control chip.

10. The chip architecture of the isolated converter of claim 1, wherein the primary side control chip, the primary side drive chip, and the primary side transistor are capable of being co-packaged, and the secondary side main control chip and the secondary side rectification transistor are co-packaged.

11. The chip architecture of the isolated converter of claim 9, wherein the primary side control chip, the primary side drive chip, the primary side transistor, the primary side demodulation chip, the secondary side modulation chip, the secondary side main control chip, and the secondary side rectification transistor are co-packaged, while the protocol chip is separately packaged.

12. The chip architecture of the isolated converter of claim 9, wherein the primary side control chip, the primary side drive chip, the primary side transistor, the primary side demodulation chip, the secondary side modulation chip, the secondary side main control chip, the secondary side rectification transistor, and the protocol chip are co-packaged.

13. The chip architecture of the isolated converter of claim 1, wherein the primary side control chip, the primary side drive chip, the primary side transistor the primary side demodulation chip, the secondary side modulation chip, and the secondary side main control chip are co-packaged, while the secondary side rectification transistor is separately packaged.

14. An isolated converter, comprising:
a transformer; and
the chip architecture of the isolated converter according to claim 1.
